(19) United States
(12) Patent Application Publication
(10) Pub. No.: US 2015/0242514 A1
(43) Pub. Date: Aug. 27, 2015

(54) CONTAINER BASED SOCIAL NETWORKING PLATFORM

(71) Applicant: ourPangea, Austin, TX (US)

(72) Inventor: Noah Simon, Austin, TX (US)

(73) Assignee: ourPangea, Austin, TX (US)

(21) Appl. No.: 14/188,570

(22) Filed: Feb. 24, 2014

(51) Int. Cl. G06F 17/30; G06F 3/0484; G06F 3/0482

(52) U.S. Cl. CPC G06F 17/30867; G06F 17/30598; G06F 3/0482; G06F 3/04842

(57) ABSTRACT

Describe herein are techniques for providing a social networking platform having multiple containers arranged organically into multiple tiers or levels. For example, in some implementations, the social networking platform described herein utilizes multiple communities formed from the containers and based on user-generated or system-perceived connections, relationships and/or interactions to model real life relations between individuals and/or entities.

### BACKGROUND

Today many people interact with various social networking platforms to communicate and connect with other individuals, as well as business entities and organizations. Typically, users of the social networking platforms distribute information via either a direct user to user messaging service and/or some interface for posting or sharing information on user pages.

Unfortunately, typical social networking platforms are focused exclusively on users and user pages. These systems generally have a rigid predefined structure in which the user may manually add content to predefined areas of the user's page. While some social networking platforms may allow business and/or organizations to own pages, the pages are defined or oriented with content areas that reflect content typically associated with an individual person not with a business or an organization. Additionally, these platforms organize the individual user pages in a linear manner, i.e. each page is assigned to an individual, with no hierarchal organization.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system architecture including multiple devices accessing one or more servers hosting a social networking platform, according to some implementations.

FIG. 2 illustrates an example community within the social networking platform of FIG. 1, according to some implementations.

FIG. 3 illustrates another example community including a user defined community within the social networking platform of FIG. 1, according to some implementations.

FIG. 4 illustrates an example community including two sub-communities which share a container within the social networking platform of FIG. 1, according to some implementations.

FIG. 5 illustrates an example of content aggregation between containers of a community for providing auto-updated content, according to some implementations.

FIG. 6 illustrates an example of content aggregation between containers of a community for providing time-based content according to some implementations.

FIG. 7 illustrates an example interface for viewing a container associated with a user, according to some implementations.

FIG. 8 illustrates an example interface for viewing a container associated with a mid-level container, according to some implementations.

FIG. 9 illustrates an example interface for viewing a container associated with a top-level container, according to some implementations.

FIG. 10 illustrates an example architecture of a device configured to host the social networking platform, according to some implementations.

FIG. 11 illustrates an example flow diagram for receiving and classifying data to be posted as content, according to some implementations.

FIG. 12 illustrates an example flow diagram for displaying content, according to some implementations.

FIG. 13 illustrates an example flow diagram for creating a community, according to some implementations

### DETAILED DESCRIPTION

This disclosure includes techniques and arrangements for providing a social networking platform. In particular, this disclosure describes a social networking platform having multiple containers that may be arranged organically into multiple tiers or levels. For example, in some implementations, the social networking platform described herein utilizes multiple communities formed from the containers and based on user-generated or system-perceived connections, relationships and/or interactions to model real life relations between individuals and/or entities (e.g., businesses, originations, groups, etc.).

In some examples, each of the containers may be related to an individual, entity, and/or topic or interest group and contains content associated with the particular individual, entity and/or group to which the container is assigned. The content may include various types of data posted by one or more users and/or collected from related containers. For example, a container may include user comments or discussions, photos, calendars, biographical information, news articles, events, statistics, among others. In some cases, the content is posted or added to the particular container that published the content. In other instances, the content is collected or aggregated from other containers having a connection and/or relationship with the publishing container.

In some implementations, the entity or an administrator for the entity may be able to define and arrange a community of containers to more accurately represent a true structure of the entity. For example, a business may define and arrange containers related to various departments, sub-departments, products, services, support, etc. to accurately reflect the corporate structure of the business. For instance, the business may generate an internal community including containers for each department and sub-department within the company. The business may then invite employees to join various departments and/or sub-departments based on an individual employee's status within the business.

In other implementations, the social networking platform may include organically generated communities, as well as user defined communities. For instance, in some examples, a user may define or create multiple containers and explicitly arrange the container into a community. In other examples, the system may generate or form communities based on perceived or detected relationships, common interests, and/or similar topics. In some implementations, communities may be formed to reflect real world communities such as neighborhoods, cities, counties, states, countries, etc. In another example, communities may be formed around interests, such as, for instance, hobbies (e.g., kite flying, stamp collecting, bird watching, etc.), sports or games (e.g., skiing, baseball, Scrabble®, etc.), restaurants, places (e.g., parks, rivers, lakes, etc.), products or companies (e.g., Apple's iPhone®, Microsoft Windows®, etc.), topics (e.g., health care, abortion, the gold standard, etc.), among others. In some cases, a community (such as the business community) may be linked or related to a larger community, such as the community representing the country in which the business is incorporated.

In some implementations, the social networking platform may be configured to provide automatic content renewal or updating in addition to user generated or posted content. For example, the social networking platform may be configured to aggregate or combine content from lower level containers into higher level containers to provide organically generated or aggregated content. In some cases, the social networking platform may be configured to time-stamp content as the content is generated or posted and to display or publish the content based on the time-stamps.

Additionally, in some implementations, the social networking platform may include a tier-based navigation graphical user interface (GUI) for navigation through the various tiers of a community, as well as a time-based navigation GUI for navigating through various points in time related to the community. In this manner, a user of the social networking platform may seamlessly navigate or view content at various granularities based on user and/or entity relationships as well as time. For example, a user may be able to view content related to an event that took place on Apr. 23, 2013 in Austin, Tex. and to view comments related to the event posted by other users that have a relationship with the city of Austin, with the state of Texas, with the United States or even comments from users around the world.

The user may also view the comments at various levels (e.g., user, group, city, state, world) based on time and data of posting, for instance, in chronological order starting at the event date of Apr. 23, 2013 and moving forward until the present day. In another example, a user may be able to view religious opinions of a country 10 years ago and compare those religious opinions with the same country today. In some instances, the user may be able to view religious opinions at various geographic regions within the country and determine how those views have changed over time.

In some particular implementations, the social networking platform may be configured to analyze or correlate content from various related containers and to present the content in a coherent manner. For instance, containers assigned to a geographic or political region (e.g., a container associated with a state or municipality) may present statistics related to content such as religious views (e.g., the percentage of Catholics in the region), political views (e.g., the number of people voting and the percentage that voted for a particular candidate), interests (e.g., most subscribed-to group containers within the region), hobbies or hobby groups (e.g., which groups are trending over time), population and cultural data (e.g., percentages related to race, sex, and ethnicity), among others.

In some cases, the social networking platform may publish the analyzed and/or correlated content such that the content is viewable based on time navigation to allow a user to view changes within an area (e.g., a region) over time. In some examples, the social networking platform may publish the analyzed and/or correlated content in various forms, such as graphs and charts.

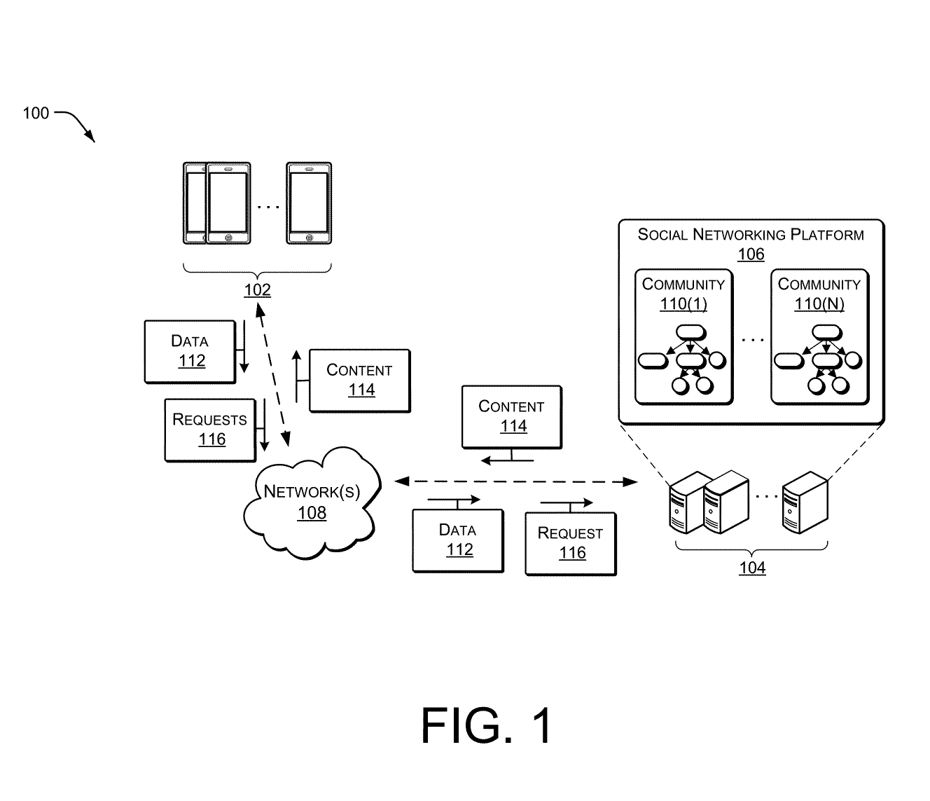

FIG. 1 illustrates an example system architecture including multiple devices 102 accessing one or more servers 104 hosting a social networking platform 106. In the illustrated implementation, the devices 102 are smart phones, while the social networking platform 106 is hosted by multiple servers 104. However, it should be understood that devices 102 and servers 104 may be any type of device including a network interface. For example, the devices 102 and servers 104 may be a desktop computer, tablet computer, electronic book reader device, household appliance, cellular phone, among others.

The devices 102 may be communicatively coupled to the servers 104 hosting the social networking platform 106 via one or more networks 108 via wired technologies (e.g., USB, fiber optic cable, etc.), wireless technologies (e.g., RF, cellular, satellite, Bluetooth, etc.), or other connection technologies. The networks 108 may be any type of communication network, including data and/or voice network, and may be implemented using wired infrastructure (e.g., cable, CATS, fiber optic cable, etc.), a wireless infrastructure (e.g., RF, cellular, microwave, satellite, Bluetooth®, etc.), and/or other connection technologies. Generally, the networks 108 carry data between the social networking platform 106 and the devices 102.

The social networking platform 106 generally refers to a network accessible platform implemented as a computing infrastructure of processors, storage, software, data access, and so forth, illustrated as servers 104, and that is maintained and accessible via one or more networks 108. Typically, the social networking platform 106 may not require end-user knowledge of the physical location and configuration of the system that delivers the services. Common expressions associated with cloud services include “on-demand computing,” “software as a service (SaaS),” “platform computing,” “network accessible platform” and so forth. For example, the social networking platform 106 may be one or more applications or modules installed on servers 104 and configured to present or display content to one or more users of the devices 102.

The social networking platform 106 maintains one or more communities 110(1)-(N) in order to present content to the users of the devices 102. In some implementations, each of the communities 110(1)-(N) are maintained as a tree-structure formed from multiple related containers. Each container of the tree may be associated with an individual, entity, topic, or group and is related to content associated with the individual, entity, topic, or group to which the container is assigned. In this manner, the social networking platform 106 may publish or present the associated content to the users of the devices 102 when the devices 102 access or view a particular container of the communities 110(1)-(N).

In the illustrated example, the devices 102 provide data 112 to the social networking platform 106. The data 112 may include user comments or discussions, photos, calendars, biographical information, news articles, events, statistics, among others that the users of devices 102 desire to be posted or associated with one or more of the containers. For example, a user may provide comments and photos related to a bass fishing tournament that the user participated in and may assign the comments and photos to a container associated with a bass fishing group (for example, “Bass Fishers of Austin”).

When received, the data 112 is time-stamped and classified based on the type. In some cases, the data 112 may also be assigned special attributes that may be used to edit, publish, filter, or aggregate the data 112 within the containers. For example, the special attributes may include location data (e.g., global position satellite (GPS) coordinates, nearest wireless tower in communication with the posting device, etc.), captions, hash tags or tags (e.g., topics or subjects related to the data 112), identifications of individuals associated with the data 112, etc. Once the data 112 is classified and time-stamped, the data 112 may be posted or published as content 114 to the container indicated by the user.

At various times, the social networking platform 106 may receive requests 116 from the devices 102 to view particular communities 110(1)-(N) or containers within the communities 110(1)-(N). In response to the requests 116, the social networking platform 106 provides published content 114 associated with the container indicated in the request 116 to the requesting device, such that the requesting device may display the published content 114 to a user, for instance, using a web-based browsing application.

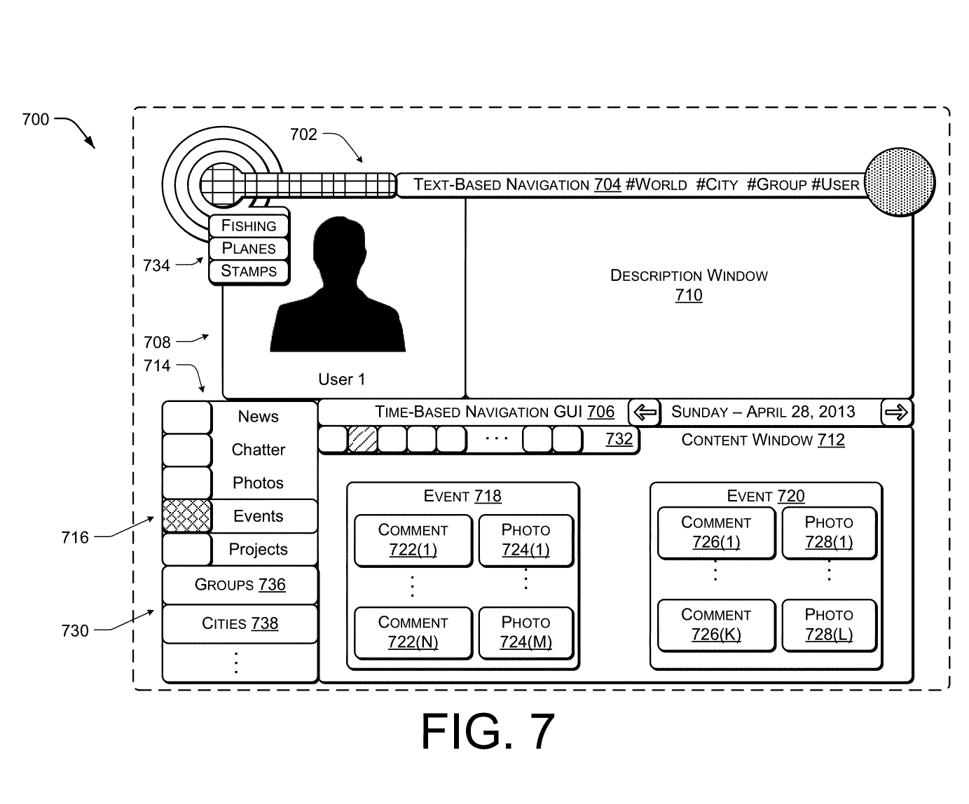

In some implementations, the social networking platform 106 selects content 114 associated with the container indicated in the request 116 based on the assigned time-stamp. For example, each container may include a time-based navigation GUI (see e.g., the time-based navigation GUI of FIG. 7), that allows the user of the device 102 to view the content 114 based on the time that the content 114 was provided or posted to the social networking platform 106. For instance, the content 114 originally returned in response to a request 116 may be the most recent content 114 added or posted to a container. The user of the device 102 may then navigate through the content 114 associated with the container using the time-based navigation GUI.

Once posted or published to a container, the content 114 associated with that container may be collected or aggregated for publication by various other containers having a connection and/or relationship with the container. For example, if the user added or posted the comments and photos of the user's bass fishing tournament to the container “Bass Fishers of Austin,” the comments and photos may be associated with other related containers, such as other fishing group containers (e.g., “Bass Fishers of Texas,” “Bass Fishers of America,” or “American Fishing”), businesses or entities related to fishing (e.g., “Bass Pro Shop® Home” or “The Original Austin Bait Store”), geographic containers (e.g., the city of Austin, Lake Travis, or the State of Texas), among others.

Once associated, the related containers may provide the comments and photos or a portion of the comments and photos to one or more of the devices 102 in response to a request 116. In this manner, the content 114 associated with each container may be organically arranged within a community, such that the content 114 of a particular container may be updated or refreshed whenever a device 102 views the particular container without the need for a user to post additional data to the particular container directly.

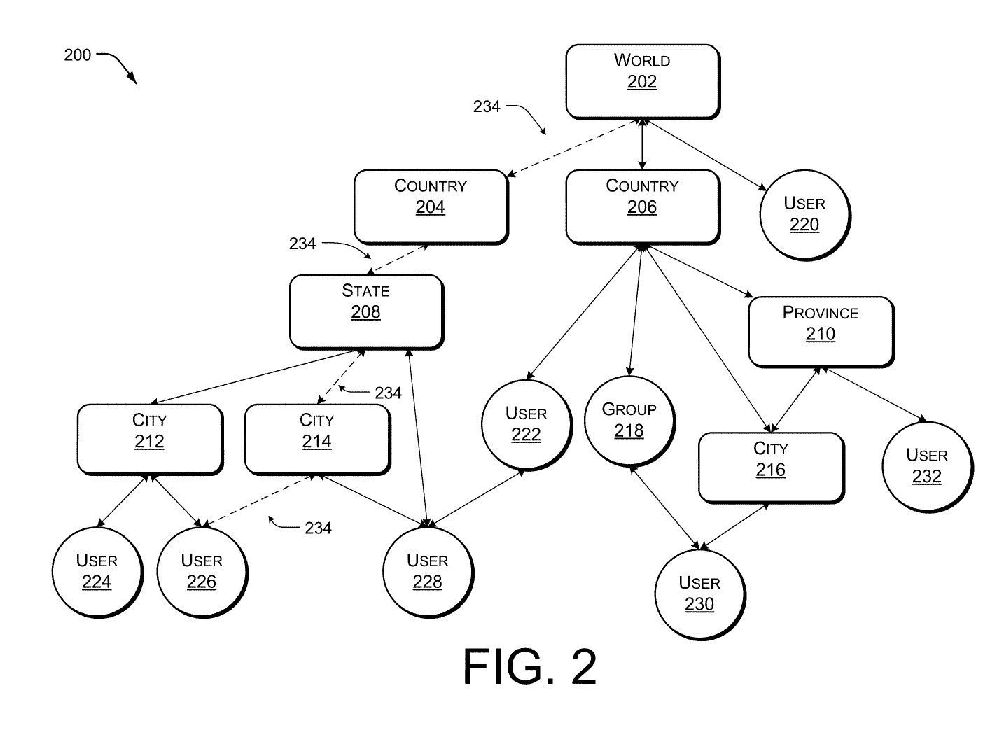

FIG. 2 illustrates an example community 200 within the social networking platform 106 of FIG. 1 according to some implementations. In the illustrated example, the community 200 is representative of geographical regions within the world. For example, the community 200 includes a root node 202 representative of the world, two containers 204 and 206 representative of countries, a container 208 representative of a state, a container 210 representative of a province, three containers 212, 214, and 216 related to cities, a container 218 related to a user, topic, or interest group, and eight containers 220-332 representative of users.

In the illustrated community 200, containers 202-232 may be related to each other either manually by a user or owner assigned to the containers or formed automatically by the social networking platform 106 based on a detected relationship. For example, user container 226 is illustrated as related to city container 214. In some cases, the administrator or owner assigned to the city container 214 may approve or deny the request to join or subscribe to the city container 214. In other cases, the user assigned to container 226 may indicate that the user lives in the city 214 (for example, by adding content related to the user's address to the container 226), and the social networking platform 106 may relate the container 226 with the container 214 automatically in response to determining that the address is within the limits of the city associated with container 214.

In the illustrated example, the user container 226 is also shown as related to city container 212, in addition to the city container 214. For instance, this may result from the fact that the user assigned to container 226 may have an address in both cities. In other instances, the user assigned to container 226 may vacation regularly in the city associated with container 212 and live in the city associated with container 214. In yet another instance, the user assigned to container 226 may simply be interested in news related to the city associated with container 212 and have no real physical world connection. In this instance, the user may manually link or define a relationship between the container 226 and the city of container 212. In other instances, connections or relations may be formed based on real world connections and/or user interest.

In the illustrated community 200, the city container 214 is also related to state container 208. Similar to the user container 226, the city container 214 may have subscribed or joined the state container 208 and/or the social networking platform 106 may have automatically associated the two based on a known real world or physical relationship. In addition, when the city container 214 is related with the state container 208, the user container 226 is also related to the state container 208. For example, content added to or associated with container 226 may be aggregated or associated with the city container 214 based on the relationship between the user container 226 and the city container 214.

The content added to the container 226 may also be associated with the state container 208 based on the relationship between the city container 214 and the state container 208. Thus, in this manner, content associated with the user container 226 may be published at any related container or containers related to a related container, etc. For example, as illustrated by path 234, user container 226 is related with world container 202 via city container 214, state container 208, and country container 204. In other words, content associated or posted to user container 226 may be displayed in response to a request to view the world container 202 or the content associated with user container 226. In this manner, world container 202 may access content associated with any lower level related container (e.g., the user containers 218-232, the group container 218, the city containers 212 and 214, the state and province containers 208 and 210, and the country containers 204 and 206), such that the content displayed by the social networking platform 106 in response to a request (e.g., the request 112 of FIG. 1) to view the world container 202 may be updated in substantially real time based on content being added or associated with lower level containers.

In some cases, two containers may be related in more than one way. For example, the user container 228 is directly related to the city container 214 and to the state container 208. For instance, the user assigned to container 228 may have related container 228 to both the city container 214 and the state container 208, as the user may live in both the city associated with the container 214 and the state associated with the container 208. Thus, the container 228 is both directly related to the state container 208 and indirectly related to the state container 208 via the city container 214.

In some cases, user containers may be related to other user containers and/or group containers. For example, as illustrated, the user container 228 is related to the user container 220 and the container 230 is related to the group container 218. Thus, in some implementations of the social networking platform described herein, each container may be related to any other container regardless of the type or subject of the respective containers.

In some implementations, the social networking platform may select aggregated content to display based on a strength of a relationship between the publishing container and the container that the aggregated content was originally associated with or the number of intervening containers between the publishing container and the original container. For example, the country container 206 may be configured to publish content originally associated with the container 218 opposed to content originally associated with the container 228, as the container 218 is directly related to the country container 206, while the container 228 is not.

In the illustrated example, user container 228 is related to user container 222, such that data associated with the container 228 or the user of container 228 may be aggregated or associated with the container 222. However, in other implementations, the social networking platform may be configured such that user containers, such as containers 222 and 228, may be prevented from subscribing or forming a direct relationship with other user containers. In this manner, data may only be associated with a single user container but with multiple other types of containers (e.g., groups, cities, states, countries, and the world).

Additionally, in some implementations, the social networking platform may filter content associated with particular types of relations. For example, the user container 226 is related to the country container 206 via the city container 214, the user container 228, and the user container 222. However, the country container 206 may avoid publishing or displaying content originally associated with the user container 226 due to the fact that the city associated with the container 214 is located physically within the country associated with the container 204 rather than the country associated with the container 206. Thus, the content originally associated with the container 226 is unlikely to be related to the subject matter of the container 206.

In another example, each container of the social networking platform may be configured to publish or display content collected from lower level tiers but not containers associated with higher level tiers. For example, the container 210 may be configured to publish content associated with the containers 216, 230, and 232 but to refrain from publishing content associated with the container 206, as the container 206 is at a higher tier and, therefore, may contain content that is inappropriate or unrelated to the topic of the province container 210.

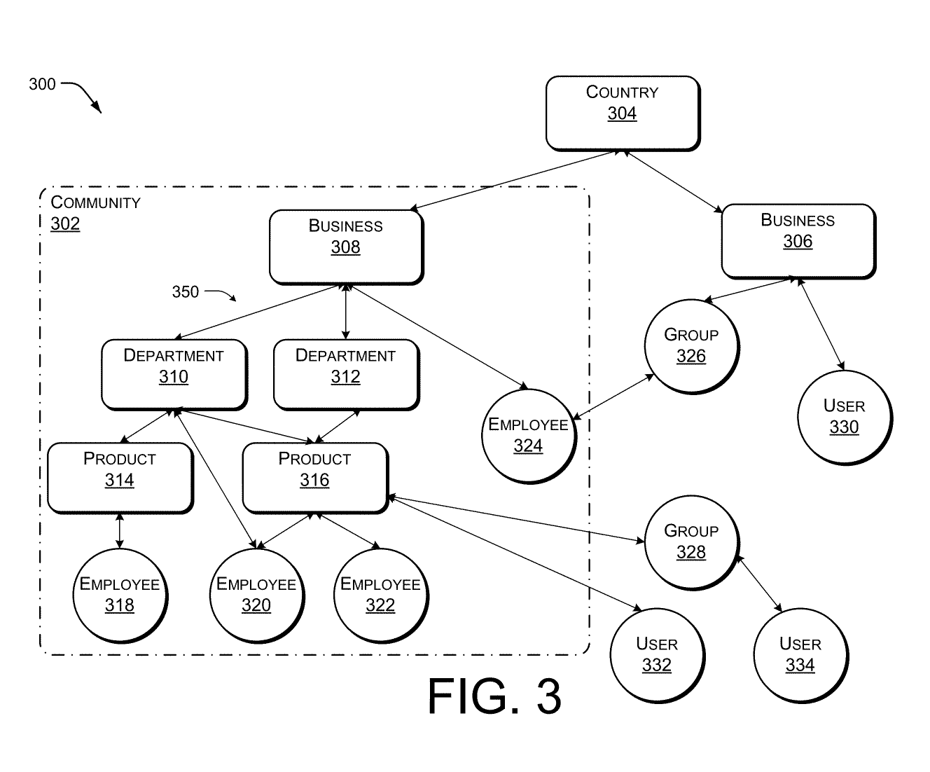

FIG. 3 illustrates another example community 300 including a user defined community 302 within the social networking platform 106 of FIG. 1 according to some implementations. In the illustrated example, the community 300 includes a country container 304, two business containers 306 and 308, two department containers 310 and 312, two product containers 314 and 316, four employee containers 318-324, two group containers 326 and 328, and three user containers 330, 332, and 334. In FIG. 3, the (user defined) community 302 includes a sub-community related to the business or entity of container 308. In the illustrated example, the community 302 includes the containers 308-316 that are assigned to and managed by the same user or entity, in this example the business associated with the container 308, and the containers 318-324 are assigned to or owned by the employees of the business.

In the illustrated example, each of the containers 308-316 may be defined or created by the business entity associated with the container 308. For instance, an administrator employed by the business may create each of the containers 308-316 based on a corporate structure of the business. In the illustrated example, the business includes two departments represented by the containers 310 and 312 and two products represented by the containers 314 and 316.

In some instances, the department associated with the container 310 may be responsible for the product assigned to container 314, while the departments associated with both of the containers 310 and 312 may be at least partially responsible for the product assigned to the container 316. For example, the department associated with the container 310 may be a manufacturing department that produces the products of both the containers 314 and 316, while the department associated with the container 312 may be an engineering department that is assigned to upgrade the product assigned to the container 316. Thus, unlike traditional social networking platforms, the social networking platform described herein may allow businesses or other entities to accurately reflect the structure of the organization since the business is able to define multiple containers, as well as the relationship between the containers.

Once the entity containers (i.e., the containers 308-316) are defined, the entity may invite the employees to subscribe to particular containers. For example, the employee assigned to the container 318 may be invited to subscribe to the container 314 as the employee may work on the product assigned to the container 314. Likewise, the employee assigned to the container 320 may be invited by the business to subscribe to both the container 310 and the container 316, as the employee assigned to the container 320 may work for the department associated with the container 310 and on the product assigned to the container 316. In this way, the individual employees of the business associated with the container 308 may subscribe or view content from the containers related to the individual employee's work while keeping sensitive information private (e.g., information from other departments).

In some implementations, the business associated with the container 308 may select various containers to be viewable by the general public. For instance, the business associated with the community 302 may wish to develop interest in a new product represented by the container 316. The business associated with the community 302 may thus make the container 316 open to the public. Thus, as illustrated, the user assigned to the container 332 (shown outside the dashed line representing the community 302) may subscribe to the container 316 to view information about the product assigned to the container 316. For instance, the user assigned to the container 332 may wish to track the development of the product associated with the container 316.

It should also be understood, that in some implementations, the containers 318-324 may be used by the employees as the employee's user or personal container and, thus, may not be controlled by the business entity associated with the community 302. Thus, in some cases, the containers 318 and 320 may be related to containers outside of community 302. For instance, in the illustrated example, the container 324 is related to the container 326. In other instances, the business associated with the community 302 may block or activate privacy rules that prevent content associated with the business defined containers (e.g., the containers 308-316) from being published or associated with the containers 304, 306, and 326-334 outside of the community 302 even if a relationship such as the relationship between the container 324 and the container 326 exists.

In other implementations, a privacy setting may be applied on a container by container basis. For example, the container 316 may have a privacy setting enabled to allow only users whom have successfully subscribed to the container 316 (e.g., applied and been approved) to view data associated with the container 316. In one particular implementation, a container may have a privacy setting that prevents data associated with the container from being aggregated or published by a parent container. For example, container 308 (i.e., the top level container associated with community 302) may have a privacy setting enabled that prevents data associated with the container 308 or a lower level container, such as containers 310-316, from being associated with container 304.

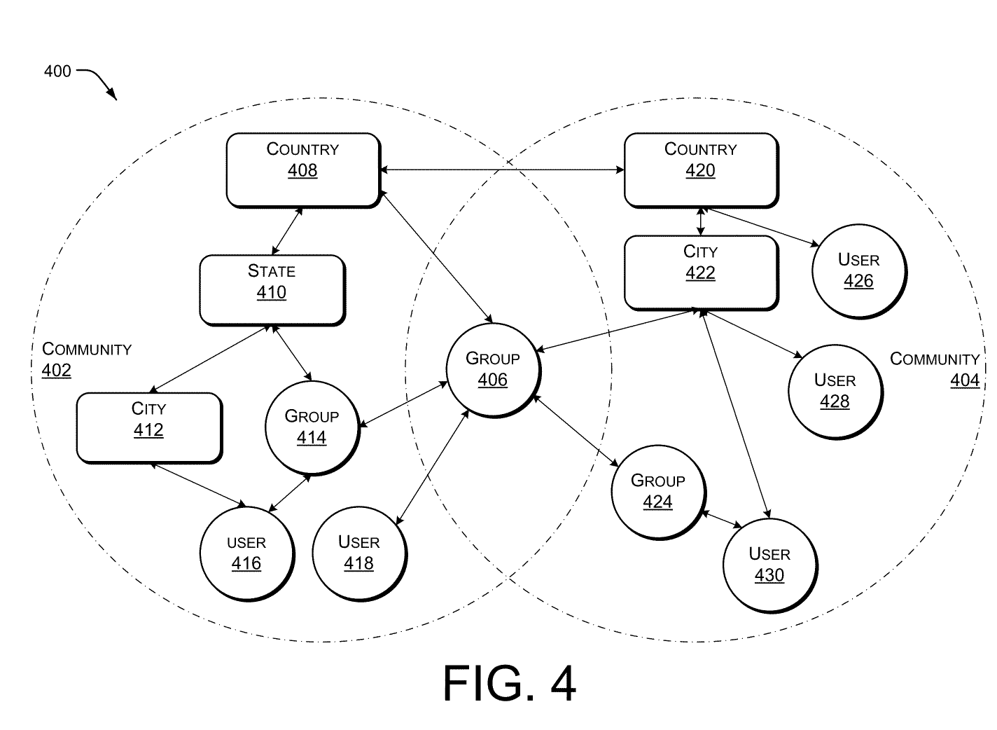

FIG. 4 illustrates an example community 400 including two sub-communities 402 and 404 that share a container 406 within the social networking platform 106 of FIG. 1, according to some implementations. In the illustrated example, the community 402 includes a country container 408, a state container 410, a city container 412, two group containers 406 and 414, and two user containers 416 and 418. The community 404 includes a country container 420, a city container 422, two group containers 406 and 424, and three user containers 426, 428, and 430.

In the illustrated example, the container 406 is shared by both community 402 and community 404. For instance, the container 406 may be related to a group such as “Science Fiction Fans” and both the country associated with the container 408 and the country associated with the container 420 include users (e.g., users assigned to the containers 416, 418, and 430) that are members of the group “Science Fiction Fans.” Thus, in some implementations, a container, such as container 406, may be included in multiple communities and/or multiple sub-communities within the social networking platform.

Additionally, in the illustrated example, group container 414 is shown as a member of the community 402 but not a member of the community 404, while the container 424 is shown as a member of the community 404 but not a member of the community 402. For instance, the country associated with the container 408 may be Canada and the country associated with the container 420 may be the United States of America. Thus, the container 424 may be “Science Fiction Fans of America” and the container 414 may be “Science Fiction Fans of Canada,” both of which are related to “Science Fiction Fans.” Thus, a container, such as the container 406, may have lower level related containers from multiple unrelated communities.

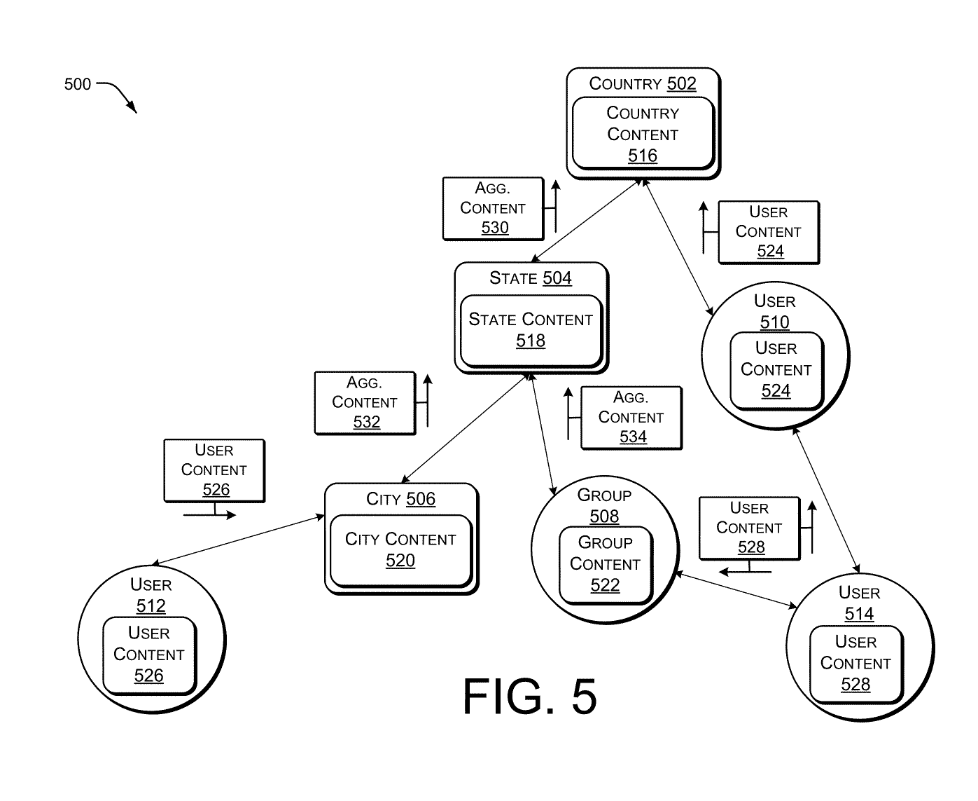

FIG. 5 illustrates an example of content aggregation between containers of a community 500 for providing auto-updated content, according to some implementations. In the illustrated example, the community 500 is related to a country associated with a container 502 and includes a state container 504, a city container 506, a group container 508, and three user containers 510, 512, and 514.

Each of the containers 502-514 includes associated content. For example, the country container 502 includes country content 516, the state container 504 includes state content 518, the city container 506 includes city content 520, the group container 508 includes group content 522, and the user containers 510, 512, and 514 include user content 524, 526, and 528 respectively.

Generally, the user content 524, 526, and 528 is received at the social networking platform from a user and includes the content published or displayed by the social networking platform in response to a request to view the respective container 510, 512, or 514. For example, a user may generate user content by uploading comments, photos, and/or other textual and visual information to the user's container, complete surveys or questionnaires, add events or tasks to a calendar, etc. In some instances, the user content 524, 526, and 528 may be posted by another user that is authorized to access and post to another user's container. In some cases, third party content that may be added to a user container may be limited by the user to certain areas (e.g., a public discussion), certain topics, and/or certain types of data (e.g., comments and photos but not calendared events).

The country content 516, the state content 518, the city content 520 and the group content 522 may include content posted by one or more users directly to the associated containers 502-508 or content that has been collected from related containers, such as user content 524, 526, and/or 528, as well as aggregated content 530, 532, and 534. Generally, the country content 516, the state content 518, the city content 520 and the group content 522 includes the content published or displayed by the social networking platform in response to a request to view the respective containers 510, 512, or 514.

The aggregated content 530, 532, and 534 may include the user content 524, 526, and 528, in addition to content posted directly to the group container 508, the city container 506, and/or the state container 504. For example, the aggregated content 534 may include user content 528 and the group content 522, the aggregated content 532 may include user content 526 and the city content 520, and the aggregated content 530 may include the aggregated content 532 (e.g., the user content 526 and the city content 520), the aggregated content 534 (e.g., the user content 528 and the group content 522), and the state content 518.

Thus, in the illustrated example, content posted or associated with a particular container may become associated with higher level containers (e.g., the user content 526, the city content 520, and the state content 518 may become associated with the country container 502 as shown by the aggregated content 532 and 534). In this manner, content published or presented in response to requests at a higher level container (e.g., the country container 502) may in large part include content originally associated with other lower level containers (e.g., the container 504-528). Additionally, the content published or presented in response to requests at a higher level container may be refreshed or updated as new content is added to one or more of the related lower level containers. For example, in some implementations, the content for publication may be selected based on statistical data related to the content (e.g., a number of votes, views, and/or users associated with a particular content item), subjects of the content, amount of related content, subject of the publishing container, type of content, metadata or features of the content, or a combination thereof.

While in the illustrated example, the content is aggregated upward, in some implementations, content may be aggregated between any two related containers. For example, the group container 508 is at a higher level than the user container 514. However, in some implementations, the group content 522 may be associated with user container 514.

In the illustrated examples of FIGS. 2-5, the leaf containers are displayed as circles and the interior containers are displayed as rectangles, however, it should be understood that in some implementations, the basic container structure related to each type of container may be the same.

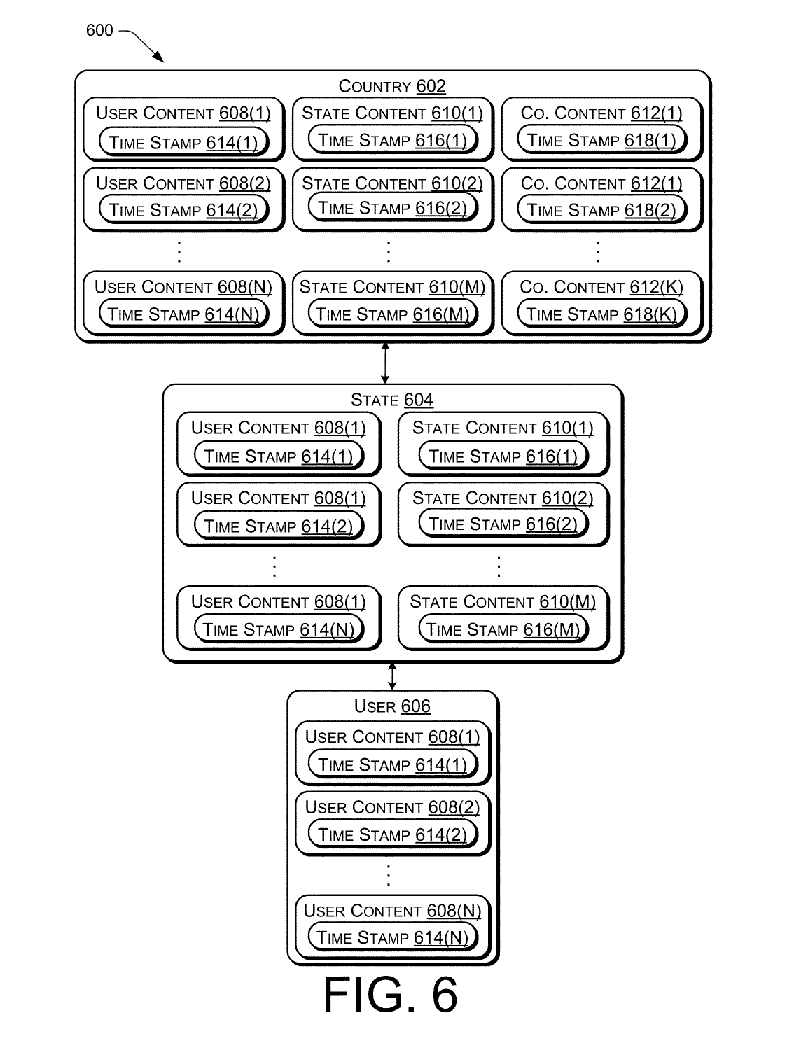

FIG. 6 illustrates an example of content aggregation between containers of a community 600 for providing time-based content, according to some implementations. The community 600 includes a high level container 602 related to a country, a mid level container 604 related to a state, and a low level container 606 related to a user. As illustrated, each of the containers 602, 604, and 606 includes content originally associated with the container. For example, the user container 606 is associated with user content 608(1)-(N), the state container 604 is associated with state content 610(1)-(M), and the country container 602 is associated with country content 612(1)-(K).

As described above with respect to FIG. 5, the content 608(1)-(N) and 610(1)-(M) are associated with higher level containers. For example, the user content 608(1)-(N) is also associated with the containers 604 and 606 and the state content 610(1)-(M) is associated with the container 602. Thus, the container 602 is associated with the user content 608(1)-(N), the state content 610(1)-(M), and the country content 612(1)-(K).

In some implementations, as the social networking platform receives data to be associated with the various containers 602, 604, and/or 606, the social networking platform time-stamps each of the content items, such that the content associated with each of the containers 602, 604, and 606 may be published or presented to a user in response to a request to view the container based on the age of the time-stamp. Thus, each of the user content items 608(1)-(N) includes a respective time-stamp 614(1)-(N), each of the state content items 610(1)-(M) includes a respective time-stamp 616(1)-(M), and each of the country content items 612(1)-(K) includes a respective time-stamp 618(1)-(K).

In general, the social networking platform may publish or present content to a requesting user based on the age of the time-stamp. For instance, the social networking platform may publish the most current content associated with a container. In other instances, the social networking platform may include a user interface with a time-based navigation GUI and the social networking platform may publish or present content in response to a request based on the time period indicated by the time-based navigation GUI.

In one specific implementation, the social networking platform may publish or present content in one day time periods based on a date selected using the time-based navigation GUI. In this implementation, the social networking platform may compare the time-stamp of content items associated with the requested container to determine and only publish content items whose time-stamp falls within the time period (e.g., time-stamped on the date selected). In other implementations, the time period may be set to a predetermined number of minutes, hours, days, weeks, months, years, etc.

In some implementations, the social networking platform may publish or present content based both on the original container associated with the content and the time-stamp. For example, when a request to view the container 602 is received, the social networking platform may present the most recent country content 612(1)-(K) received in addition the most recent aggregated content (e.g., either the user content 608(1)-(N) or the state content 610(1)-(M)). Thus, in some instances, the content published in response to a request to view the container 602 may or may not include the user content 608(1)-(N) and/or the state content 610(1)-(M) based on the time-stamp associated with each of the content items 608(1)-(N) and 610(1)-(M), as well as the time period indicated by the time-navigation GUI.

FIG. 7 illustrates an example interface 700 for viewing a container associated with a user according to some implementations. The interface 700 includes two tier-based navigation GUIs, including a pyramidal navigation GUI 702 and a text-based navigation GUI 704, as well as a time-based navigation GUI 706. In the illustrated example, the interface 700 also includes a container selection navigation GUI 730. The interface 700 also includes a user window 708, a description window 710, and a content window 712 for presenting content to a user viewing the container. In some implementations, the interface 700 may also include a content filter GUI 714, as well as an attribute filter GUI 732.

The tier-based navigation GUIs 702 and 704 may be utilized by a user to select a container that the user desires to view. For example, the pyramidal navigation GUI 702 is illustrated as a series of consecutive rings from which the user may select to move up and down the levels of the community being viewed. For instance, in the illustrated example, the user is viewing the lowest level of the community (e.g., a user container) and the innermost ring of the pyramidal navigation GUI 702 is selected. Likewise, the text-based navigation GUI 704 allows a user to select the community and specific container within the community that the user desires to view, for instance, as illustrated using the hash tag identifiers followed by the container name. In the illustrated example, the user container is selected in the text-based navigation GUI 704 as the text-based navigation GUI 704 includes “#world” (e.g., highest level container of a community), “#city” (e.g., the second highest level container of a community), “#group” (e.g., a container one level up from the user container), and “#user” (e.g., the currently selected container).

In some examples, such as the illustrated example, the pyramidal navigation GUI 702 may include a drop-down container selector 734 option to further improve the usability of the social networking platform. For instance, in the illustrated example, the group level container is selected (for instance, by the user hovering a mouse over the second innermost circle of the pyramidal navigation GUI 702) and, in response, the drop down GUI 734 is displayed. The drop down GUI 734 may provide a selectable list of containers that are related to the user container currently being displayed. For instance, in the illustrated example, the drop down GUI 734 is displaying group containers that the user has subscribed, i.e., a group container related to “fishing,” a group container related to “planes,” and a group container related to “stamps.” By providing the drop down GUI 734, the interface 700 allows the user to more easily navigate between various containers, particularly when multiple containers are arranged at the same level of the community being viewed. Further, it should be understood, that while three containers (e.g., “fishing,” “planes,” and “stamps”) are shown in the illustrated example, the drop down GUI 734 may include any number or variety of containers.

In some implementations, the container selection navigation GUI 730 may be included in addition to the tier-based navigation GUIs 702 and 704 for providing quick access to various containers. For instance, in the illustrated example, the container selection navigation GUI 730 includes selectable container types (e.g., groups 736 and cities 738). In some cases, a user may select a container type from the container selection navigation GUI 730 and in response the interface 700 may present a drop down menu or GUI that the user may utilize to navigate directly to a particular container of the corresponding type. Additionally, it should be understood, that while two types of containers (e.g., “groups” and “cities”) are shown in the illustrated example, the container selection navigation GUI 730 may include any number or variety of types of containers, for instance, based on the number of levels in the community being viewed.

The time-based navigation GUI 706 may be configured to allow the user to navigate through the content associated with the currently selected container based on the time-stamps of each content item. For example, as illustrated, currently Sunday, Apr. 28, 2013 is selected and, therefore, the social networking platform displays content having a time-stamp of Apr. 28, 2013 in the content window 712. In other instances, the time-based navigation GUI 706 may be based on a predetermined number of minutes, hours, days, weeks, months, years and/or the time-period may be user configurable. In some implementations, the time-based navigation GUI 706 may also allow a user to view content prior to a selected date and/or following a selected date.

In the illustrated example, the interface 700 includes the user window 708 and the description window 710, in addition to the content window 712. In some examples, the content displayed in the user window 708 and the description window 710 may be static, while the content displayed in the content window 712 may be variable. For instance, the user window 708 may include a photograph of the user and the description window 710 may include biographical information (e.g., bio, address, sex, race, religion, marital status, culture, political affiliations, education, etc.) related to the user of the container being displayed. In some implementations, the static content may be displayed regardless of the time period selected in the time-based navigation GUI 706.

The content window 712 may display the variable content, such as photographs, comments, news articles, events, projects, among others. In some implementations, the content displayed in the content window 712 is based at least in part on the time period selected via the time-based navigation GUI 706. To illustrate, FIG. 7 shows an example in which the content window 712 is currently displaying content related to two events 718 and 720.

The content filter GUI 714 may allow the user to filter or sort the content associated with a container based on content type. For example, in addition to displaying content in the content window 712 based on the period of time selected via the time-based navigation GUI 706, a user may sort or filter the types of content presented in the content window 712 using the content filter GUI 714. For example, one or more types may be assigned to a particular content item when the content item is received by the social networking platform and a user may select various filters, such as news, chatter, photos, events, projects, etc. that cause only content having an associated type (i.e., news, chatter, photos, events, projects) to be displayed. In the illustrated example, the event filter 716 is selected and the content window 712 is currently displaying content related to the events 718 and 720.

In addition to the content filter GUI 716, the interface 700 may also include the attribute filter GUI 732. The special content filter GUI 716 may provide additional filters that the user may select to further refine the content being displayed in the content window 712. For example, one or more special attributes may be assigned to a particular content item when the content item is received by the social networking platform based on the type associated with the content item. For instance, if the content item is a photo, the content item may have special attributes assigned such as the identity of locations, individuals, or places exhibited in the photo, a subject or topic of the photo, containers or user the photo has been associated with, major and minor colors associated with the photo, one or more timestamps, textual content associated with the photos (e.g., comments and/or captions), among others. In one particular implementation, the number and type of filters provided by the attribute filter GUI 732 may be based on the number and type of particular attributes associated with the content type selected in the content filter 714. For instance, the special content filters displayed by the attribute filter GUI 732 when the event filter 716 is selected in the content filter GUI 716 may be different than the special content filters displayed when the news filter is selected in the content filter GUI 716.

In some examples, content may be added to or assigned to the events 718 and 720, in addition to containers. For instance, in the illustrated example, the event 718 has been assigned comments 722(1)-(N) and photos 724(1)-(M) and the event 720 has been assigned comments 726(1)-(K) and photos 728(1)-(L). In some particular implementations, the time-stamp of the content may be associated with the events 718 or 720, such that the event was created within the time period specified or taking place within the time period in the time-based navigation GUI 706. In other particular implementations, the time-stamp may associated with the content assigned to the events 718 or 720, such that when some content associated with the event 718 or 720 was edited or posted within the time period specified in the time-based navigation GUI 706, the corresponding event 718 or 720 is displayed in the content window 712.

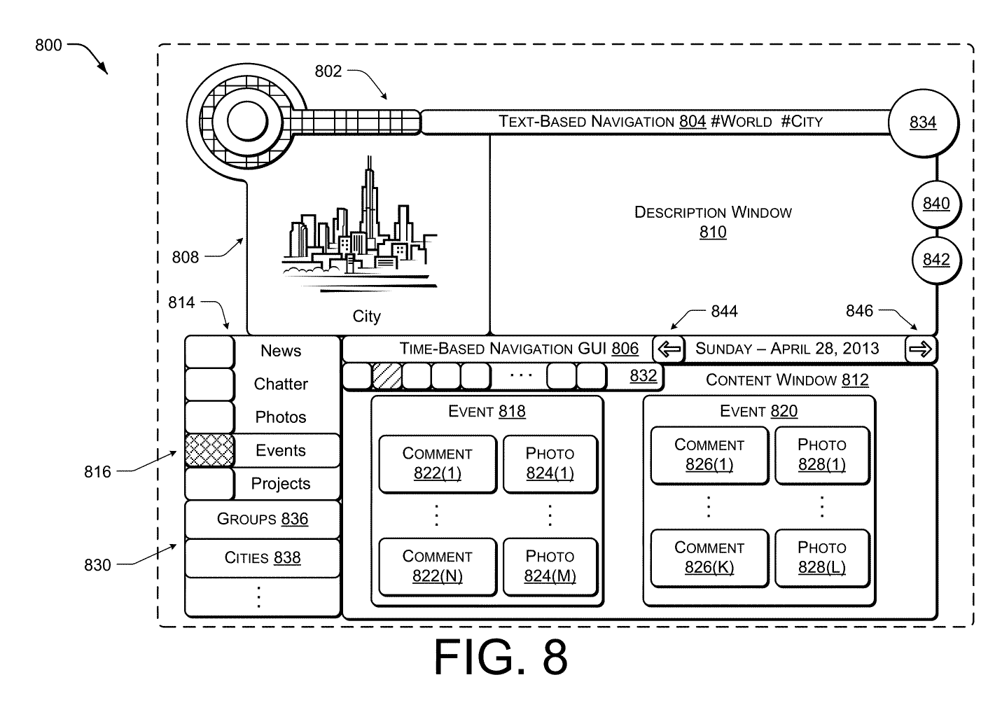

FIG. 8 illustrates an example interface 800 for viewing a container associated with a mid-level container according to some implementations. The interface 800 includes two tier-based navigation GUIs, including a pyramidal navigation GUI 802 and a text-based navigation GUI 804, as well as a time-based navigation GUI 806. In the illustrated example, the interface 800 also includes a container selection navigation GUI 830. The interface 800 also includes user window 808, a description window 810, and a content window 812 for presenting content to a user viewing the container. In some implementations, the interface 800 may also include a content filter GUI 814, as well as an attribute filter GUI 832.

The tier-based navigation GUIs 802 and 804 may be utilized by a user to select a container that the user desires to view. For instance, the pyramidal navigation GUI 802 is illustrated as a series of consecutive rings from which the user may select to move up and down the levels of active the community. For instance, in the illustrated example, the user is viewing a mid-level container within a community (e.g., a city container). Thus, a mid-level ring (e.g., the second innermost ring) of the pyramidal navigation GUI 802 is selected. Likewise, the text-based navigation GUI 804 allows a user to select the community and specific container within the community that the user desires to view. For instance, in the illustrated example, the text-based navigation GUI 804 has selected the city container of the community being viewed and includes the hashtags “#world” and “#city.”

In some implementations, the container selection navigation GUI 830 may be included in addition to the tier-based navigation GUIs 802 and 804 for providing quick access to various containers. For instance, in the illustrated example, the container selection navigation GUI 830 includes selectable container types (e.g., groups 836 and cities 838). In some cases, a user may select a container type from the container selection navigation GUI 830 and in response the interface 800 may present a drop down menu or GUI that the user may utilize to navigate directly to a particular container of the corresponding type. Additionally, it should be understood, that while two types of containers (e.g., “groups” and “cities”) are shown in the illustrated example, the container selection navigation GUI 830 may include any number or variety of types of containers, for instance, based on the number of levels in the community being viewed.

In some implementations, the interface 800 may also include a home or profile button 834. The home or profile button 834 may be presented to provide the user with a quick manner to return to the user's personal container. For example, the user may be able to select button 834 and return directly to the interface associated with the user's personal container (e.g., interface 700 of FIG. 7). Thus, in this manner, a user is able to quickly return to the user's container even when the user's container is not associated with the community being viewed (e.g., the user's container has no relationship with the city being displayed in FIG. 8). In some cases, such as when the user is viewing the user's container, the button 834 may be disabled or grayed out (e.g., as illustrated in FIG. 7).

The time-based navigation GUI 806 is configured to allow the user to navigate through the content associated with the currently selected container based on the time-stamps of the content item. For example, as illustrated, currently Sunday, Apr. 28, 2013 is selected and, therefore, the social networking platform displays content having a time-stamp of Apr. 28, 2013 in the content window 812. In other instances, the time-based navigation GUI 806 may be based on a predetermined number of minutes, hours, days, weeks, months, years and/or the time-period may be user selectable. In some implementations, the time-based navigation GUI 806 may also allow a user to view content prior to a selected date and/or following a selected date. For instance, the user may move back in time by accessing the left arrow 844 and forward in time by utilizing the right arrow 846.

In the illustrated example, the interface 800 includes the user window 808 and the description window 810, in addition to the content window 812. In some examples, the content displayed in the user window 808 and the description window 810 may be static, while the content displayed in the content window 812 may be variable. For instance, the user window 808 may include a photograph of the city related to the container being viewed, and the description window 810 may include information (e.g., history, population demographics, political leaders, key industries, etc.) related to the city of the container being displayed.

In other implementations, the content displayed in the user window 808 and the description window 810 may vary over time. For example, if the user window 808 includes one or more photographs of the city, the photograph may be updated based on the time/date displayed in the time-based navigation GUI 806, such that the user may visually view the changes to the city over time. In another example, the content displayed in the description window 810 may be generated based on an analysis of content added to lower level containers related to the current container. Additionally, the content displayed in the user window 808 and the description window 810 may be selected algorithmically by the social networking platform or by one or more users of the social networking platform. For instance, the description window 810 may display information related to population demographics (e.g., age, race, sex, religious views, etc.) and the population demographics may be generated by the social networking platform based on an analysis of user containers related to the city container. In this example, the content of the description window 810 may vary based on the time/date displayed in the time-based navigation GUI 806, while the content in the description window 810 may not be editable by the users of the social networking platform.

In some implementations, the interface 800 may also include a connect button 840 and/or a subscribe button 842 to relate the user's container with the current container. For example, the connect button 840 may allow a user to post content to the city container and the subscribe button 842 may be utilized by the user to cause content associated with the city container to also be associated with the user's container. In one particular instance, the subscribe button 842 may cause a feed or stream of content associated with the current container to be displayed on the user's container. The content window 812 may display user posted content or aggregated content from lower level tiers. In some implementations, the content displayed in the content window 812 is based at least in part on the time period selected via the time-based navigation GUI 806. To illustrate, in the example of FIG. 8, the content window 812 is currently displaying content related to two events 818 and 820.

The content filter GUI 814 may allow the user to filter or sort the content associated with a container based on content type. For example, in addition to displaying content in the content window 812 based on the period of time selected via the time-based navigation GUI 806, a user may sort or filter the types of content presented in the content window 812 using the content filter GUI 814. For example, one or more types may be assigned to a particular content item when the content item is received by the social networking platform and a user may select various filters, such as news, chatter, photos, events, projects, etc. that cause only content having an associated type (i.e., news, chatter, photos, events, projects) to be displayed. In the illustrated example, the event filter 816 is selected and the content window 812 is currently displaying content related to the events 818 and 820.

In addition to the content filter GUI 816, the interface 800 may also include the attribute filter GUI 832. The special content filter GUI 816 may provide additional filters that the user may select to further refine the content being displayed in the content window 812. For example, one or more special attributes may be assigned to a particular content item when the content item is received by the social networking platform based on the type associated with the content item. For instance, if the content item is a photo, the content item may have special attributes assigned such as the identity of locations, individuals, or places exhibited in the photo, a subject or topic of the photo, containers or user the photo has been associated with, major and minor colors associated with the photo, one or more timestamps, textual content associated with the photos (e.g., comments and/or captions), among others. In one particular implementation, the number and type of filters provided by the attribute filter GUI 832 may be based on the number and type of particular attributes associated with the content type selected in the content filter 814. For instance, the special content filters displayed by the attribute filter GUI 832 when the event filter 816 is selected in the content filter GUI 816 may be different than the special content filters displayed when the news filter is selected in the content filter GUI 816.

In some implementations, content may be added to or assigned to the events 818 and 820, in addition to containers. For instance, in the illustrated example, the event 818 has been assigned comments 822(1)-(N) and photos 824(1)-(M) and the event 820 has been assigned comments 826(1)-(K) and photos 828(1)-(L). In some particular implementations, the time-stamp of the content may be associated with the events 818 or 820. In other particular implementations, the time-stamp may be associated with the content assigned to the events 818 or 820.

In an example, a user may view varying levels of detail with respect to content of a community within the various windows 808, 810, and 812 by utilizing the pyramidal navigation GUI 802 and/or the text-based navigation GUI 804. For example, by moving up and down between containers at different tiers of the community, a user may view changes to demographic information in the description window 810. For instance, if the user starts by viewing a city container related to a first city, the first city may be 54% democratic voters, 36% republican voters, and 10% independent voters. The user may then move up to the state level using the pyramidal navigation GUI 802 (e.g., clicking on a ring outside of the highlighted ring), and the state may be 34% democratic voters, 57% republican voters, and 9% independent voters. The user may note that the city has a higher percentage of democratic voters than the associated state and a lower percentage of republican voters than the associated state. The user may then move back down to a second city, for example, by typing “#city name” into the text-based navigation GUI 804. Using the description window 810, the user may be informed that the second city has 23% democratic voters, 74% republican voters, and 3% independent voters. The user may then move down further to view voting ratios at various groups within each of the first and second city, as well as to view the political views of individual users at the user container level. Thus, by navigating up and down to various tiers, a user may view and compare changes in demographics on a container by container basis. In other examples, the user may view education levels, religious views, ethnic or cultural demographics, housing or income levels, industry demographics, among others.

In another example, the user may view changes to content in the content window 812. For instance, in the illustrated example, the user is viewing the comments 822(1)-(N) related to the event 818. The comments 822(1)-(N) are comments related to the city container being viewed, for example, comments made by individuals that live in the city. By moving up to the state level container, the user may view comments related to the event 818 from individuals that live within the state but not necessarily within the city. Likewise, by moving down to a group or user level container, the user may view comments on the event 818 from individual users or entities. In this manner, the user may quickly obtain an idea of how the individual views related to the event 818 change with respect to different levels of specificity. In other examples, the user may view changes in content, such as comments or opinions, related to topics of interest, sporting events, various products and services, corporations and/or businesses, individual statesmen or celebrities, etc.

In addition to viewing changes in content based on levels or tiers within the social networking platform, the user may also view changes in content over time. For example, the user may view changes in the voting demographics within the city of the container being viewed by moving forwards and backward in time using the arrows 844 and 846 of the time-based navigation GUI 806. For instance, in 1990 the city may have been comprised of 80% republican voters, 15% democratic voters, and 5% independent voters, while in 2010 the city voting demographics may have changed to 40% republican voters, 45% democratic voters, and 15% independent voters. Thus, by combining the tier-based navigation GUIs 802 and 804 with the time-based navigation GUI 806 the user may quickly view changes in content based both on time/date and at various population and/or interest levels.

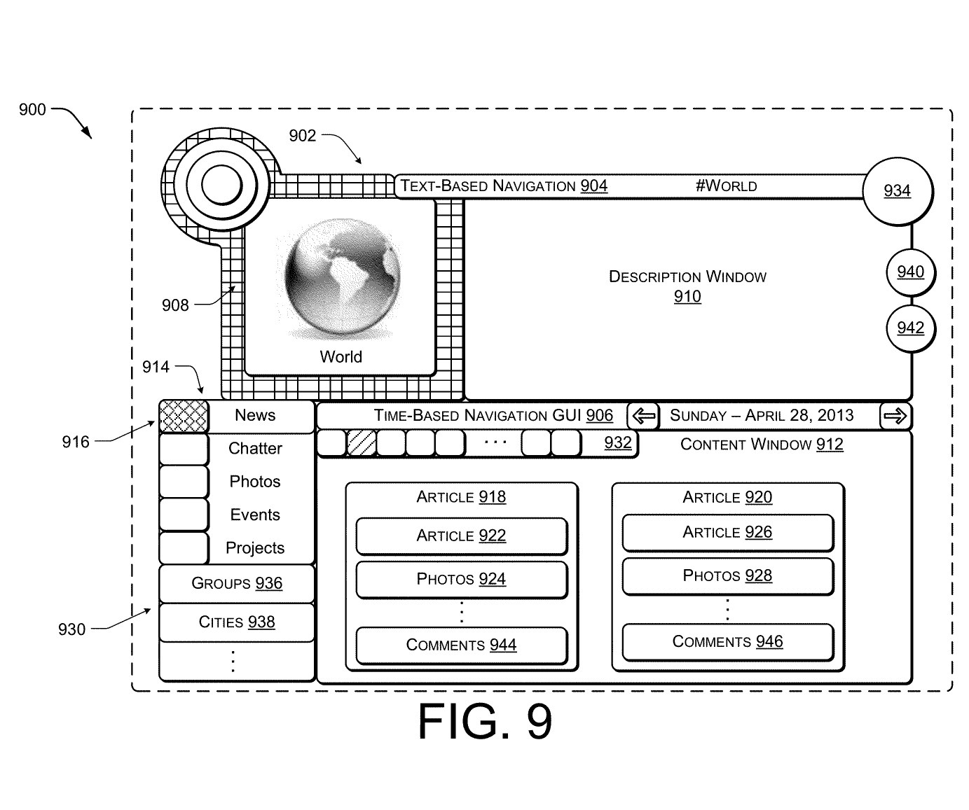

FIG. 9 illustrates an example interface 900 for viewing a container associated with a top-level container according to some implementations. The interface 900 includes two tier-based navigation GUIs, including a pyramidal navigation GUI 902 and a text-based navigation GUI 904, as well as a time-based navigation GUI 906. In the illustrated example, the interface 900 also includes a container selection navigation GUI 930. The interface 900 also includes a user window 908, a description window 910, and a content window 912 for presenting content to a user viewing the container. In some implementations, the interface 900 may also include a content filter GUI 914, as well as an attribute filter GUI 932.

The tier-based navigation GUIs 902 and 904 may be utilized by a user to select a container that the user desires to view. For instance, the pyramidal navigation GUI 902 is illustrated as a series of consecutive rings from which the user may select to move up and down the levels of the active community. In the illustrated example, the user is viewing the top level container within a community (e.g., a world container). Thus, an outermost ring of the pyramidal navigation GUI 902 is selected. Likewise, the text-based navigation GUI 904 allows a user to select the community and specific container within the community that the user desires to view. For instance, in the illustrated example, the text-based navigation GUI 904 illustrates that the world has been selected.

In some implementations, the container selection navigation GUI 930 may be included in addition to the tier-based navigation GUIs 902 and 904 for providing quick access to various containers. For instance, in the illustrated example, the container selection navigation GUI 930 includes selectable container types (e.g., groups 936 and cities 938). In some cases, a user may select a container type from the container selection navigation GUI 930 and in response the interface 900 may present a drop down menu or GUI that the user may utilize to navigate directly to a particular container of the corresponding type. Additionally, it should be understood, that while two types of containers (e.g., “groups” and “cities”) are shown in the illustrated example, the container selection navigation GUI 930 may include any number or variety of types of containers, for instance, based on the number of levels in the community being viewed.

In some implementations, the interface 900 may also include a home or profile button 934. The home or profile button 934 may be presented to provide the user with a quick manner to return to the user's personal container. For example, the user may be able to select button 934 and return directly to the interface associated with the user's personal container (e.g., interface 700 of FIG. 7). Thus, in this manner, a user is able to quickly return to the user's container even when the user's container is not associated with the community being viewed (e.g., the user's container has no relationship with the world container being displayed in FIG. 9).

The time-based navigation GUI 906 is configured to allow the user to navigate through the content of the currently selected container based on the time-stamps of each content item associated with the selected container. For example, as illustrated, the date Sunday, Apr. 28, 2013 is currently selected and, therefore, the social networking platform displays content having a time-stamp of Apr. 28, 2013 in the content window 912. In other instances, the time-based navigation GUI 906 may be based on a predetermined number of minutes, hours, days, weeks, months, years and/or the time-period may be user selectable. In some implementations, the time-based navigation GUI 906 may also a user to view content prior to a selected date and/or following a selected date.

In the illustrated example, the interface 900 includes the user window 908 and the description window 910, in addition to the content window 912. In some examples, the content displayed in the user window 908 and the description window 910 may be static. For instance, the user window 908 may include a photograph or model of the world and the description window 910 may include information (e.g., history, population demographics, political leaders, key industries, etc.) related to the world as a whole.

In other implementations, the content displayed in the user window 908 and the description window 910 may vary over time. For example, if the user window 908 includes a model of the world, the photograph may be updated based on the time/date displayed in the time-based navigation GUI 906 and/or the community that is being viewed, such that the portion of the world shown is related to the community. In another example, the content displayed in the description window 910 may be generated based on an analysis of content added to lower level containers related to the current container. For instance, the description window 910 may display information related to population demographics (e.g., age, race, sex, religious views, etc.) and the population demographics may be generated by the social networking platform based on an analysis of user containers, group containers, geographical or political containers, etc. In this example, the content of the description window 910 may vary based on the time/date displayed in the time-based navigation GUI 906, while the content in the description window 910 may not be edited by users.

In some implementations, the interface 900 may also include a connect button 940 and/or a subscribe button 942 to relate the user's container with the current container. For example, the connect button 940 may allow a user to post content the world container and the subscribe button 942 may be utilized by the user to cause content associated with the world container to also be associated with the user's container. In one particular instance, the subscribe button 942 may cause a feed or stream of content associated with the current container to be displayed on the user's container.

The content window 912 may display user posted content or aggregated content from lower level containers. In some implementations, the content displayed in the content window 912 is based at least in part on the time period selected via the time-based navigation GUI 906. For example, in the illustrated example the content window 912 is currently displaying content related to two articles 918 and 920.

The content filter GUI 914 may be configured to filter or sort the content associated with a container that is published or displayed in the content window 912. For example, in addition to displaying content in the content window 912 based on the period of time selected via the time-based navigation GUI 906, a user may sort or filter the types of content to be displayed using the content filter GUI 914. For example, one or more types may be assigned to a particular content item when the content item is received by the social networking platform. In one implementation, a user may select various filters, such as news, chatter, photos, events, projects, etc. that cause only content having an associated type (i.e., news, chatter, photos, events, projects) to be displayed in the content window 912. For instance, in the illustrated example, the news filter 916 is selected and the content window 912 is currently displaying content related to the articles 918 and 920.

In addition to the content filter GUI 916, the interface 900 may also include the attribute filter GUI 932. The special content filter GUI 916 may provide additional filters that the user may select to further refine the content being displayed in the content window 912. For example, one or more special attributes may be assigned to a particular content item when the content item is received by the social networking platform based on the type associated with the content item. For instance, if the content item is a photo, the content item may have special attributes assigned such as the identity of locations, individuals, or places exhibited in the photo, a subject or topic of the photo, containers or user the photo has been associated with, major and minor colors associated with the photo, one or more timestamps, textual content associated with the photos (e.g., comments and/or captions), among others. In one particular implementation, the number and type of filters provided by the attribute filter GUI 932 may be based on the number and type of particular attributes associated with the content type selected in the content filter 914. For instance, the special content filters displayed by the attribute filter GUI 932 when the event filter 916 is selected in the content filter GUI 916 may be different than the special content filters displayed when the news filter is selected in the content filter GUI 916.

In some implementations, content may be added to or assigned to the articles 918 and 920, in addition to containers. For instance, in the illustrated example, the article 918 has been assigned the article 922 itself, photos 924, and comments 944, and article 920 has been assigned the article 926 itself, photos 928, and comments 946. In some cases, the article may include additional types of content. In some particular implementations, the time-stamp of the content may be associated with the articles 918 or 920, such that content associated with the article 918 or 920 is displayed based on the time-stamp related to the articles 918 and 920. In other particular implementations, the time-stamp may be associated with the content assigned to the articles 918 or 920.

In an example, a user may view varying levels of detail with respect to content of a community within the various windows 908, 910, and 912 by utilizing the pyramidal navigation GUI 902 and/or the text-based navigation GUI 904. For example, by moving up and down between containers at different tiers of the community, a user may view changes to demographic information in the description window 910. For instance, if the user starts by viewing a world container, the user may determine that 35% of the world's population has a high school degree and that 20% of the world's population has a college degree. The user may then navigate down to various country level containers, for example, by typing “#country name” into the text-based navigation GUI 904. At each different country container, the description window 910 may present the percentage of the population within the particular country that has a high school degree and the percentage of the population within the particular country that has a college degree. For instance, if the country the user is viewing is the United States, the user may note that 85% of the population has a high school degree and 45% of the population has a college degree. However, if the country that the user is viewing is Kenya, the user may note that 15% of the population has a high school degree and 4% of the population has a college degree. In other examples, the user may view political demographics, religious views, ethnic or cultural demographics, housing or income levels, industry demographics, among others.

In another example, the user may view changes to content in the content window 912. For instance, in the illustrated example, the user is viewing articles 918 and 920. By navigating down to various lower level geographic related containers, the user may no longer view the articles 918 and 920, as the articles 918 and 920 may no longer be relevant within the context of a selected lower level container. Instead, the user may view different articles related to the interest and happenings within the new geographic context. For instance, the articles 918 and 920 may be related to global warming or a rice shortage that affects the entire world, while when viewing the United States container, the user may view articles related to outsourcing or unusually cold weather in the mid-west.

In addition to viewing changes in content based on levels or tiers within the social networking platform, the user may view changes in content over time. For example, the user may view changes in the education within the world by moving forwards and backward in time using the time-based navigation GUI 906. For instance, in the year 1740 only 3% of the world's population had a high school degree, while in the year 2010 34% of the world's population had a high school degree. Thus, by combining the tier-based navigation GUIs 902 and 904 with the time-based navigation GUI 906 the user may quickly view changes in content based both on time/date and at various population and/or interest levels.

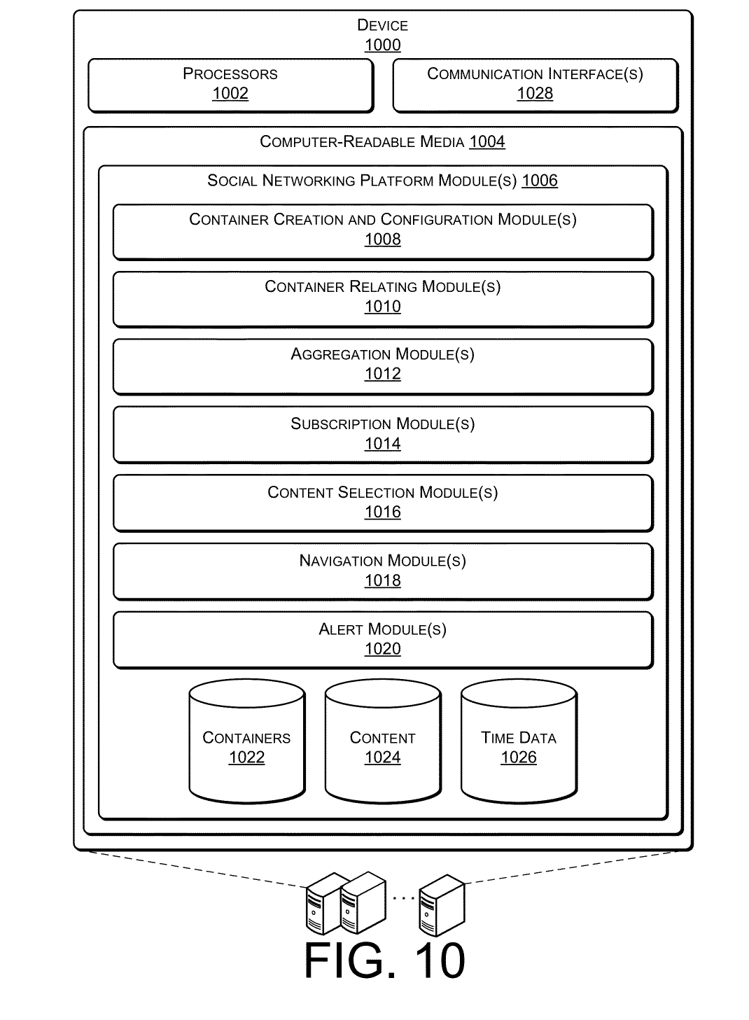

FIG. 10 illustrates an example architecture of a device 1000 configured to host the social networking platform according to some implementations. In general, one or more servers, such as servers 104 of FIG. 1, may be configured to host the social networking platform 106 and collectively comprise processing resources, as represented by processors 1002, and computer-readable storage media 1004.

The computer-readable storage media 1004 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1004 and configured to execute on the processors 1002 to perform the actions associated with the monitoring service described herein. For example, a social networking platform module 1006 may be configured to implement the social networking platform described above. For instance, the social networking platform module 1006 may include a container creation and configuration module 1008, a container relating module 1010, an aggregation module 1012, a subscription module 1014, a content selection module 1016, a navigation module 1018, and an alert module 1020.

The computer-readable media 1004 may also store data usable by the social networking platform module(s) 1006. For example, the computer-readable media 1004 may store data related to containers 1022 (e.g., arrangement of containers within communities), content 1024 (e.g., content associated with one or more containers), and time data 1026 (e.g., time-stamps related to each content item).

The device 1000 also includes one or more communication interfaces 1028 for communicating over one or more networks. The communication interfaces 1028 may support both wired and wireless connection to various networks, such as cellular networks, radio, WiFi networks, short-range or near-field networks (e.g., Bluetooth®), infrared signals, local area networks, wide area networks, the Internet, and so forth.

In an example, the social networking platform module 1006 maintains one or more communities of related containers 1022. For instance, the social networking platform module 1006 may maintain a community of containers 1022 related to a geographic area, an interest group, a topic, an event, a business, etc. which may be created, edited, related, viewed, etc. by various users of the social networking platform.

In one example, the container creation and configuration module 1008 is accessible by one or more end user devices (see e.g., the devices 102 of FIG. 1), such as a personal computer, tablet computer, smart phone, among others electronic devices. When accessed, the container creation and configuration module 1008 provides an interface for a user to create or generate one or more containers 1022. In some cases, the container creation and configuration module 1008 also includes an interface to allow a business or other entity to create a community of containers 1022, to relate the containers 1022 in a desired manner (e.g., to mimic the corporate structure or product hierarchy), and to invite specific individuals or users (e.g., employees, investors, specific customers, beta testers, sister companies, subsidiaries, etc.) to subscribe to one or more of the containers 1022 within the community. In some specific implementations, the container creation and configuration module 1008 may also allow a user to create a community related to a topic interest or hobby in lieu of a single container in a similar manner to the business communities.

Once the containers 1022 and/or communities are generated, the user or owner of the container 1022 or community may access the container relating modules 1010 to create additional communities out of the containers 1022 of one or more users or entities and to generate larger communities from the existing communities. For example, a business may relate the business community to a geographic community within which the business operates or within a topic group related to the products (e.g., a toy manufacturer may relate the manufacturer's community to a community of toy lovers). In some particular implementations, the container relating module 1010 may scan or analyze content 1024 associated with containers 1022 and relate two or more containers 1022 having similar content 1024 automatically. For example, if two of the containers 1022 include content 1024 related to an event that users of both containers 1022 are participating in, the container relating module 1010 may relate or link the two containers 1022 based on the shared event.

In one example, the social networking platform modules 1006 include an aggregation module 1012. The aggregation module 1012 may be configured to analyze content 1024 as the content 1024 is posted or added to a container and to associate the content 1024 with other containers. For example, if a user posts content 1024 to a user container, the content 1024 may be analyzed by the aggregation module 1012, and the aggregation module 1012 may determine that the content 1024 is related to baseball. The aggregation module 1012 may then determine that the user container should be related to a group container, “All About Baseball.” The aggregation module 1012 may then associate the content 1024 related to baseball with the group container. In other implementations, the aggregation module 1012 may be configured to associate content 1024 added at a particular container within a community to related containers (i.e., parent containers) arranged at a higher level of the community. Thus, in some implementations, the content 1024 may be aggregated upward through a community, while in other implementations the content 1024 may be aggregated based on the subject matter or user defined attributes of the content 1024.

In some implementations, the social networking platform 1006 includes a subscription module 1014. The subscription module 1014 may be accessible by one or more users to join particular containers 1022. For example, a user may have a particular interest in stamp collecting and, therefore, may subscribe to one or more group containers 1022 related to stamp collecting. In some instances, when a user subscribes to a container 1022, the user container associated with the user may be related to the subscribed-to container 1022, and the user may receive alerts related to content 1024 associated or posted to the subscribed-to container 1022, for example, via a special news or content feed viewable via the user's container.

The social networking platform modules 1006 may also include the content selection module 1016. The content selection module 1016 may be configured to select content to display or publish when a particular container 1022 is selected for viewing by one or more users. For instance, the content selection module 1016 may select the content 1024 to display or publish based on a time-stamp associated with the content 1024, a time period selected by the user viewing the content 1024, and/or one or more filters selected by the user viewing the content 1024.

The social networking platform modules 1006 may also include the navigation module 1018. The navigation module 1018 may include one or more tier-based navigation GUIs, such as the tier-based navigation GUIs 702, 704, 802, 804, 902, and 904 of FIGS. 7, 8, and 9, and/or one or more time-based navigation GUIs, such as the time-based navigation GUIs 706, 806, and 906 of FIGS. 7, 8, and 9. The navigation GUIs may be configured to allow a user to view content 1024 associated with various containers 1022 within a community over time. For example, the user may utilize the tier-based navigation GUIs to view content 1024 associated with containers 1022 at various levels within the community and may utilize the time-based navigation GUIs to view content 1024 posted over various time periods. In this manner, the user may be able to see how views, interests, topics, etc. change at various population levels, interest levels, as well as over various periods of time.

In some implementations, the social networking platform modules 1006 include the alert module 1020. The alert module 1020 may be configured to provide alerts, such as messages, text-messages, e-mails, instant messages, or notifications, related to new content 1024 added or posted to a container 1022 to which the user has subscribed. In some instances, the alert module 1020 may cause new content 1024 associated with one or more subscribed-to containers 1022 to be viewable in a special feed or window within the user's personal container.

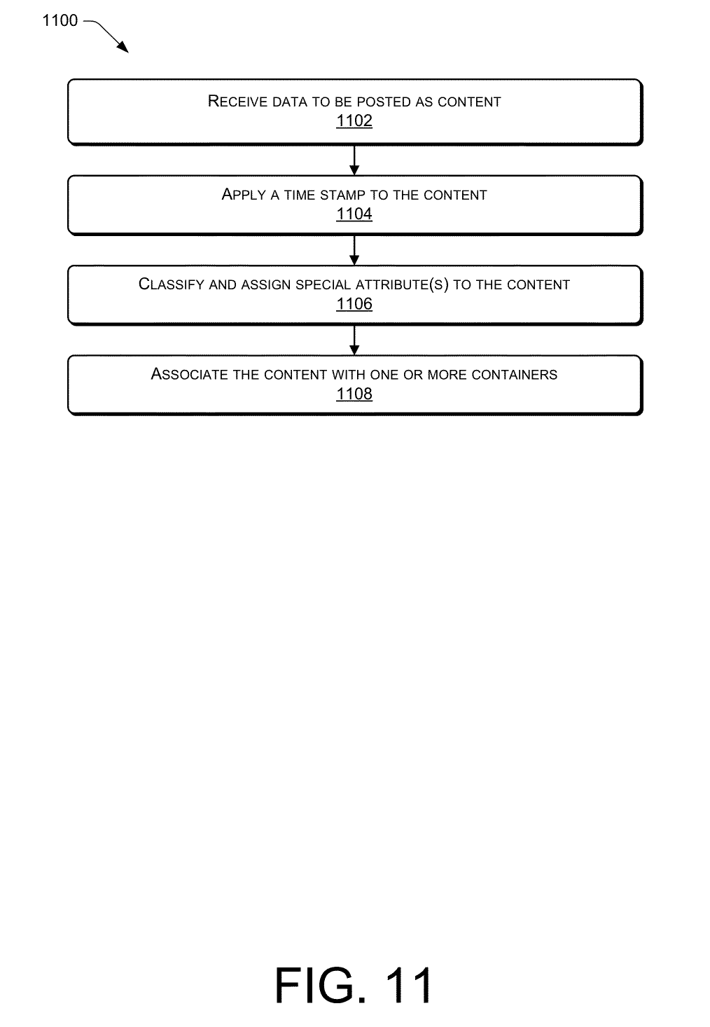

FIGS. 11-13 are flow diagrams illustrating example processes for implementing the social networking platform described above. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 11 illustrates an example flow diagram 1100 for receiving and classifying data as content according to some implementations. At 1102, the social networking platform receives data to be posted as content at one or more containers. For example, a user may provide information, news, comments, photos, videos, events, etc. to post to the user's container.

At 1104, the social networking platform applies a time-stamp to the content. For instance, the social networking platform may apply a date and time-stamp, such that when a user views a container the social networking platform may sort or filter the content associated with the container based at least in part on the date and time-stamp. In one example, the social networking platform may present the content associated with a container based on a period of time, such as a day, and the social networking platform may utilize the time-stamp to determine which period of time to associate with the content.

At 1106, the social networking platform classifies and assigns special attribute(s) to the content. For example, the social networking platform may categorize the content based on subject matter and/or type. The social networking platform may also assign various special attributes, such as image type, one or more filters, publisher, topic, among others. In some instances, the special attributes may be utilized by the social networking platform to select which content to display when a user views a particular container.

At 1108, the social networking platform associates the content with one or more containers. For example, the social networking platform may associate the content with one or more containers indicated by the user posting the content. In another example, the social networking platform may select one or more containers for the content to be associated with based on various factors, such as subject matter, type, arrangement of containers within the community, time-stamp, information related to the user posting the content or the user viewing the content, filters selected by the user viewing the content, among others.

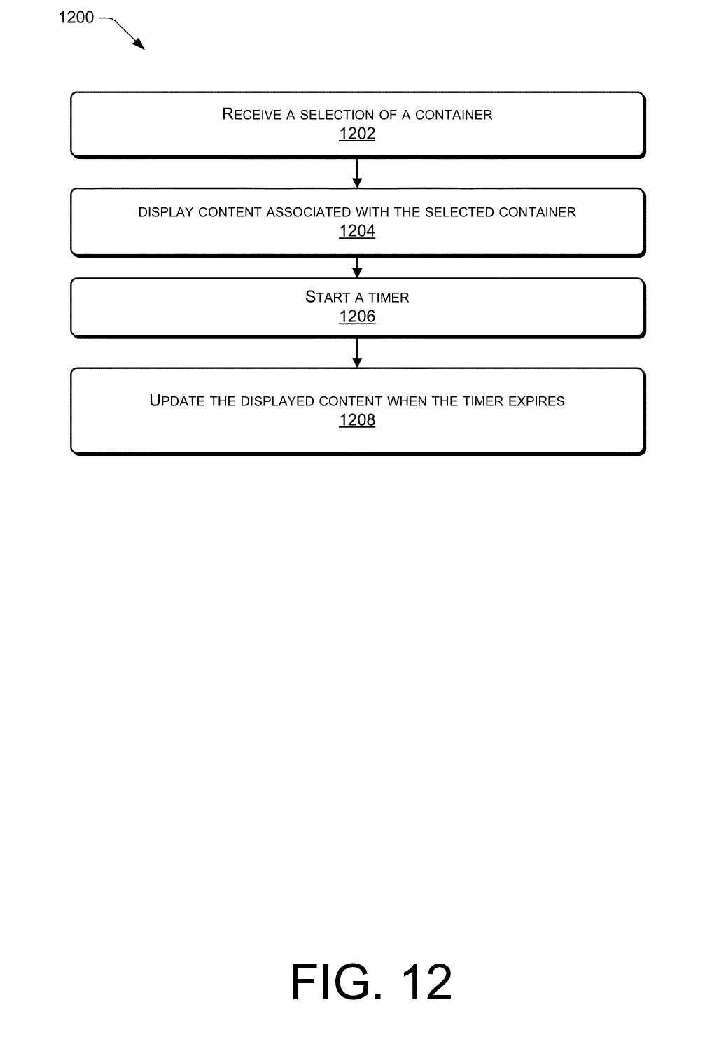

FIG. 12 illustrates an example flow diagram 1200 for displaying content according to some implementations. At 1202, the social networking platform receives a selection of a container. For example, the user may select the container using the pyramidal navigation GUI and/or the text-based navigation GUI described above with respect to FIGS. 7-9.

At 1204, the social networking platform displays content associated with the selected container. For instance, the social networking platform may select the content to be displayed based on a time-stamp associated with the content and a time period selected by the user. In another instance, the social networking platform may select the content based on the type of content and/or one or more filters elected by the users. For example, the user may select to filter the content being displayed to publish only news articles and the social networking platform may select content having the “news” type. In some implementations, the social networking platform may also select content based on one or more special attributes assigned to the content at the time of posting.

At 1206, the social networking platform starts a timer. The timer may be utilized to generate an automatic refresh of the content being displayed at the container. At 1208, the social networking platform updates the displayed content when the timer expires. For example, at higher level containers new content posted at lower level containers may be associated with the higher level container and the timer may be utilized to cause an update of the content. In this manner, the user may view current chatter or activity related to a container in substantially real time, as the content is received by the social networking platform.

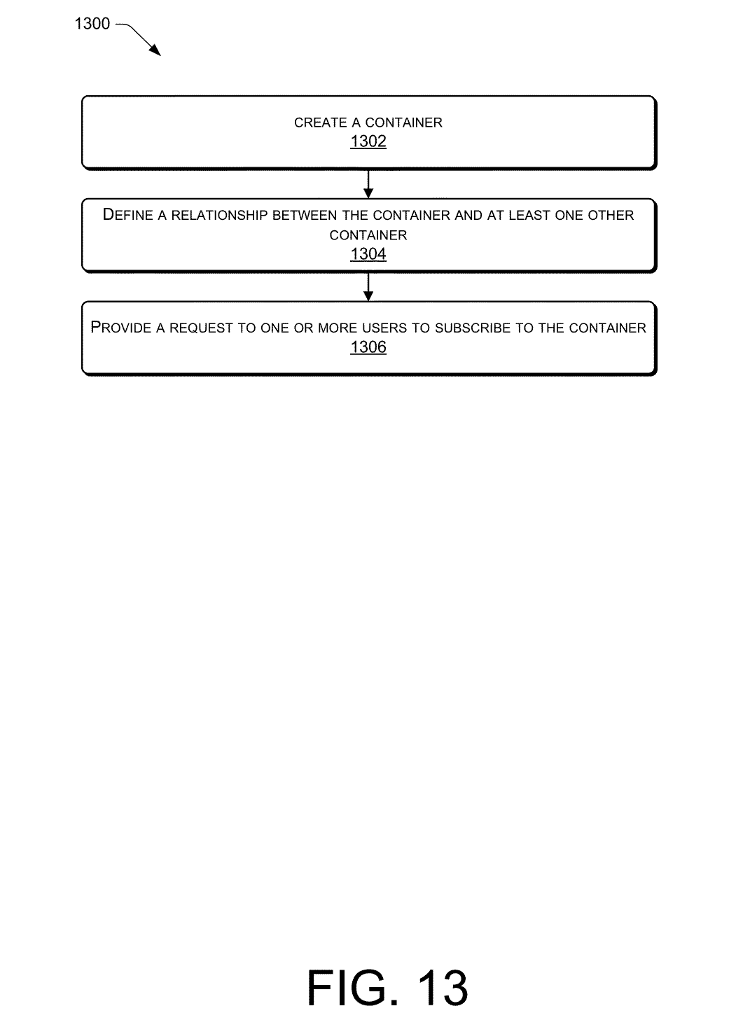

FIG. 13 illustrates an example flow diagram 1300 for creating a community according to some implementations. At 1302, a user creates a container using the social networking platform described herein. For example, the user may desire to create a community related to sports and, thus, create a “baseball enthusiast” group.

At 1304, the user defines a relationship between the container and at least one other container. For example, the user may relate the “baseball enthusiasts” group with an “American Sports” group to create a sports themed community. In some cases, the user may have also created the group “American Sports.” In some specific cases, the user may create multiple sports based groups, such as “hockey enthusiasts,” “soccer enthusiasts,” “basketball enthusiasts,” “football enthusiasts,” etc. The user may then relate each of the enthusiasts groups with the “American Sports” group to create the community. In some specific examples, the user may define the relationships in a manner desired to create a hierarchy of containers within the community.

At 1306, the user provides a request to one or more other users to subscribe to the container. In some instances, the user may have invited the one or more other users to join or subscribe to the “baseball enthusiasts” group. In other cases, a user may provide the request in response to receiving a indication from one or more of the other users that the other users desire to join the community. In some specific instances, the user may approve the other users once the other users have accepted the invite to join the community.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A method comprising:
receiving a plurality of user defined relationships between individual containers of a first subset of a plurality of containers;
generating a first community by arranging the containers of the first subset of containers based at least in part on the plurality of user defined relationships, the first community including a first tier having at least a first container of the first subset and a second tier arranged at a level below the first tier of the first community and including a second container of the first subset, the second container of the first subset related to the first container of the first subset;
associating content representative of the second container of the first subset with the first container of the first subset;
detecting a plurality of inferred relationships between individual containers of a second subset of containers of the plurality of containers;
generating a second community by arranging the containers of the second subset of containers based at least in part on the plurality of inferred relationships, the second community including a first tier having at least a first container of the second subset of containers and a second tier arranged at a level below the first tier of the second community and including a second container of the first subset of containers related to the first container of the second subset; and
associating content representative of the second container of the second subset with the first container of the second subset.

2. The method as recited in claim 1, wherein the second container of the first subset is the second container of the second subset.

3. The method as recited in claim 1, wherein the inferred relationships between containers are determined based at least in part on one of:
similar content;
shared subscription base;
similar primary topic or subject matter;
shared locations; or
shared events.

4. The method as recited in claim 1, wherein each of the first subset of containers are related to a particular geographical area.

5. A device comprising:
one or more input interfaces;
a display;
one or more communication interfaces for communicating with a server device;
one or more processors; and
computer-readable storage media storing computer-executable instructions, which when executed by the one or more processors cause the one or more processors to:
present an graphical user interface (GUI) on the display, the user interface including a pyramidal based navigation menu, a text-based navigation menu, and a time-based navigation menu;
receive a first user input to select one of a plurality of containers via at least one of the pyramidal based navigation menu or the text-based navigation menu;
receive a second user input to select a time period via the time-based navigation menu;
provide a request to the server device to view the selected one of the plurality of containers, the request including the time period;
receive content from the server device in response to the request based in part on the time period and in part on the selected one of the plurality of containers, the received content including content associated with one or more other containers related to the selected container; and
present the received content on the display.

6. The device as recited in claim 5, wherein:
the plurality of containers are arranged in multiple tiers based on predetermined relationships; and
the selected one of the plurality of containers is arranged at a first tier and includes content associated with the one or more other containers are arranged at a tier below the first tier.

7. The device as recited in claim 5, wherein the time period is a date.

8. The device as recited in claim 5, wherein the computer-readable storage media further stores computer-executable instructions, which when executed by the one or more processors cause the one or more processors to:
receive a third user input via a content selection menu of the GUI to select a content type; and
filter the received content based at least in part on the selected content type.

9. The device as recited in claim 5, wherein the computer-readable storage media further stores computer-executable instructions, which when executed by the one or more processors cause the one or more processors to:
receive a third user input via a attribute selection menu of the GUI to select an attribute; and
filter the received content based at least in part on the selected attribute.

10. The device as recited in claim 5, wherein the received content is related to at least one of the following:
education;
culture;
employment;
ethnicity;
hobby;
special interest;
volunteer work;
one or more geographic areas;
religion; or
corporate or business information.

11. The device as recited in claim 5, wherein the computer-readable storage media further stores computer-executable instructions, which when executed by the one or more processors cause the one or more processors to:
receive additional content from the server device, the additional content being associated with at least one of the one or more other containers at a time after the received content was presented on the display; and
updating the GUI to present the additional content on the display.

12. One or more computer-readable media having computer-executable instructions that, when executed by one or more processors, cause the one or more processors to perform operations comprising:
maintaining a plurality of containers, the plurality of containers including at least a first container and a second container, the second container including content representative of a user or an entity;
modeling at least one community by arranging the plurality of containers in multiple tiers, the multiple tiers including at least a first tier and a second tier arranged at a level below the first tier, wherein the first tier includes the first container and the second tier includes the second container;
determining that the first container is related to the second container; and
associating the content representative of the user or the entity with the first container in response to determining that the first container is related to the second container.

13. The one or more computer-readable media as recited in claim 12, wherein the determining that the first container is related to the second container is in response to receiving a user input indicating that the first container is related to the second container.

14. The one or more computer-readable media as recited in claim 12, wherein the determining that the first container is related to the second container is in response to determining a subject matter of the first container is related to at least a portion of the content associated with the second container.

15. The one or more computer-readable media as recited in claim 12, having computer-executable instructions that, when executed by the one or more processors, cause the one or more processors to:
receive a request from a device, via one or more communication interfaces, to view the first container;
selecting content associated with the first container to display, the selected content including the content representative of the user or the entity; and
providing the selected content to the device.

16. The one or more computer-readable media as recited in claim 15, wherein the selected content is selected based at least in part on one or more time-stamps of the content associated with the first container and in part on a time period received in the request.

17. The one or more computer-readable media as recited in claim 12, wherein the first container is related to a geographic area and the second container is related to a user that lives within the geographic area.

18. The one or more computer-readable media as recited in claim 12, wherein the first container is related to a topic and the second container includes content related to the topic.

19. The one or more computer-readable media as recited in claim 12, wherein the content representative of the user or the entity is related to at least one of the following:
education of the user;
culture of the user;
employment of the user;
ethnicity of the user;
one or more topics of interest to the user;
one or more geographic areas related to the user;
religious views of the user;
corporate or business information related to the entity; or
type of housing associated with the user or the entity.

20. The one or more computer-readable media as recited in claim 12, having computer-executable instructions that, when executed by the one or more processors, cause the one or more processors to:
wherein the plurality of containers includes a third container arranged on a third tier of the multiple tiers, the third tier being arranged above the first tier; and
associate the content representative of the user or the entity with a third container when the third container is related to the first container.
